(19) United States
(12) Patent Application Publication
(10) Pub. No.: US 2009/0179716 A1
(43) Pub. Date: Jul. 16, 2009

(54) RF Filter Device

(75) Inventor: Simon D. Gay, Medford, MA (US)

Correspondence Address: BOND, SCHOENECK & KING, PLLC, 10 BROWN ROAD, SUITE 201, ITHACA, NY, 14850-1248, US

(73) Assignee: Anaren, Inc., East Syracuse, NY (US)

(21) Appl. No.: 12/351,573

(22) Filed: Jan. 9, 2009

Related U.S. Application Data
(60) Provisional application No. 61/020,075, filed on Jan. 9, 2008.
(60) Provisional application No. 61/057,420, filed on May 30, 2008.

(51) Int. Cl. H01P 1/20; H01P 11/00; H01P 3/08

(52) U.S. Cl. 333/204; 29/600

(57) ABSTRACT

The present invention is directed to an integrated filter device for an implantable element. The device includes at least one filter component having N-circuit layers, N being an integer greater than or equal to one. Each of the N-circuit layers includes a first dielectric material having a first conductive material disposed thereon, the first dielectric material being characterized by a relatively low dielectric constant. The first conductive material is characterized by a relatively high electrical conductivity and arranged in a predetermined pattern on a surface of the first dielectric material of each of the N-circuit layers. The first conductive material on each of the N-circuit layers is coupled to the first conductive material disposed on an adjacent layer of the N-circuit layers such that the N-circuit layers form an inductor disposed in parallel with a first capacitance. At least one tuning element is coupled to the at least one filter component and configured to tune the at least one filter component to resonate at a predetermined selected resonance frequency. The at least one tuning element includes a second dielectric material characterized by a relatively high dielectric constant. A dimension of the at least one tuning element and the predetermined selected resonance frequency are a function of a ratio of the high dielectric constant over the low dielectric constant.

### CROSS-REFERENCE TO RELATED APPLICATIONS

This application claims priority to U.S. Provisional Patent Application Ser. No. 61/020,075 filed on Jan. 9, 2008, and U.S. Provisional Patent Application Ser. No. 61/057,420 filed on May 30, 2008, the contents of which are relied upon and incorporated herein by reference in their entirety, and the benefit of priority under 35 U.S.C. § 19(e) is hereby claimed.

### BACKGROUND OF THE INVENTION

1. Field of the Invention

The present invention relates generally to medical devices, and particularly to implantable medical devices.

2. Technical Background

There are various types of implantable medical devices currently in-use that transmit electrical stimulation signals into human tissue, receive electrical signals generated by the human body or both. Examples of such devices include cardiac pacing devices (so-called pace-makers) and cardioversion/defibrillation devices. Of course, such devices may be employed in other areas of the body (e.g., spine, vagas nerve, brain, etc.) to provide electrical stimulation or signal monitoring.

When an implantable medical device, such as a cardiac monitor, pacemaker, defibrillation device, etc. is implanted in the human body, electrical leads may be disposed within the body tissue to sense or stimulate that tissue based on the purpose of the device. Using the cardiac related devices as an illustrative example, endocardial leads may be routed transvenously to position sensing or stimulation electrodes, disposed at the end of the lead, at a desired location in a chamber of the heart or a blood vessel of the heart. The electrode surface must be accurately positioned against the endocardium, or within the myocardium, to properly sense cardiac electrograms or properly stimulate the heart chamber. The endocardial leads typically include one or more insulated conductive wires surrounded by an insulating outer sleeve. Depending on the application, an endocardial cardiac lead may include a single conductor, or two or more conductors. One end of the lead is connected to the device by a connector; the far or distal end of the lead is connected to a stimulation and/or sensing electrode.

In some applications, the lead consists of an internal conductor comprising multiple strands of wire surrounded by an insulating material. The lead also includes a second conductor comprised of multiple strands of wire. The second conductor is surrounds the insulating material that covers the inner conductor. Finally, the composite structure that includes inner and outer conductors is covered by an outer jacket of a second insulating material. In other words, the construction of the lead is similar to a coaxial cable in that it forms a four port device. At the far or distal end of the lead that is proximate the tissue, the electrode that is connected to the inner conductor is known as the TIP electrode and the electrode that is connected to the outer conductor is referred to as the RING electrode. The near or proximal end of the lead is connected to the implantable medical device. Multiple leads can be connected to a single implanted medical device.

Those of ordinary skill in the art will understand that the use of the MRI process with patients who have implanted pacemakers is often problematic. During an MRI procedure, of course, the body is subjected to both RF energy as well as a magnetic field. The RF energy may be inductively coupled into the conductors and RF currents will be induced. As those of ordinary skill in the will appreciate, when current flows through resistive elements (such as conductive leads and/or electrodes), so-called I²R heating occurs. Accordingly, intense and injurious heating may occur along the length of the wire and at the electrodes that are attached to the heart wall. The generated heat may be extreme and potentially dangerous. Thus, patients with implantable devices are generally advised not to undergo magnetic resonance imaging (MRI) procedures. One major concern in the TIP/RING lead described above relates to heating at the tip and ring. The reason for this concern relates to the fact that there is a high concentration of RF currents at these points.

What is needed, therefore, is an implantable MRI compatible medical device configured to resist, minimize, inhibit or prevent RF heating during MRI procedures. In particular a filter device is needed that will not cause or contribute to the heating of body tissue during an MRI scan, or cause or contribute to the damaging of implanted electrical circuitry during an MRI scan due to RF current flow on an implanted lead. What is further needed is a filter that is configured to choke, block, inhibit or otherwise reduce RF current flow at the TIP and the RING nodes of a four-port lead arrangement. The required filter may also be needed at the two ports of the proximal end of the lead. In fact, the needed filter device may be employed at both the TIP and the RING electrodes. The proximal end of the lead may also require two filters. Depending on the application, additional filters could also be placed at mid-portions of the lead to inhibit RF current flow. Finally, the implantable medical device may require one or more filters disposed in internal portions thereof to choke, block, inhibit or otherwise reduce RF current flow.

### SUMMARY OF THE INVENTION

The present invention addresses the needs described above by providing an implantable MRI compatible medical device configured to resist, minimize, inhibit or prevent RF heating during MRI procedures. The filter device of present invention will not cause or contribute to the heating of body tissue during an MRI scan, or cause or contribute to the damaging of implanted electrical circuitry during an MRI scan due to RF current flow on an implanted lead. The filter of present invention may be configured to choke, block, inhibit or otherwise reduce RF current flow at the TIP and the RING nodes of a four-port lead arrangement. The filter of present invention may be disposed at the two ports of the proximal end of the lead. In fact, the filter device of the present invention may be employed at both the TIP and the RING electrodes. The proximal end of the lead may also require two filters. Depending on the application, additional miniaturized filters of the present invention are configured to disposed at mid-portions of an implantable lead to inhibit RF current flow. Finally, the implantable miniaturized filters of the present invention may be disposed in internal portions of an implantable medical device to choke, block, inhibit or otherwise reduce RF current flow.

One aspect of the present invention is directed to an integrated filter device for an implantable element. The device includes at least one filter component having N-circuit layers, N being an integer greater than or equal to one. Each of the N-circuit layers includes a first dielectric material having a first conductive material disposed thereon, the first dielectric material being characterized by a relatively low dielectric constant. The first conductive material is characterized by a relatively high electrical conductivity and arranged in a predetermined pattern on a surface of the first dielectric material of each of the N-circuit layers. The first conductive material on each of the N-circuit layers is coupled to the first conductive material disposed on an adjacent layer of the N-circuit layers such that the N-circuit layers form an inductor disposed in parallel with a first capacitance. At least one tuning element is coupled to the at least one filter component and configured to tune the at least one filter component to resonate at a predetermined selected resonance frequency. The at least one tuning element includes a second dielectric material characterized by a relatively high dielectric constant. A dimension of the at least one tuning element and the predetermined selected resonance frequency are a function of a ratio of the high dielectric constant over the low dielectric constant.

In another aspect, the present invention includes a method for making a miniaturized integrated filter device for an implantable element. The method includes: a) providing N-layers of dielectric material, the dielectric material being characterized by a relatively low dielectric constant, N being an integer value greater than or equal to one; b) disposing a first conductive material on each of the N-layers of dielectric material to form N-circuit layers, the first conductive material being characterized by a relatively high electrical conductivity and arranged in a predetermined pattern on a surface of the first dielectric material; c) integrating the N-circuit layers to form an inductor disposed in parallel with a first capacitance; and d) providing at least one tuning element either before the step of integrating or after the step of integrating to form a filter component, the at least one at least one tuning element including a second dielectric material characterized by a relatively high dielectric constant and configured to tune the filter component to resonate at a predetermined selected resonance frequency, a dimension of the at least one tuning element and the predetermined selected resonance frequency being a function of a ratio of the high dielectric constant over the low dielectric constant.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a schematic diagram of the filter device in accordance with one embodiment of the present invention;

FIGS. 2A-2C are detail views of the filter device shown in FIG. 1 in accordance with an embodiment of the present invention;

FIGS. 3A-3B are detail views of the filter device shown in FIG. 1 in accordance with another embodiment of the present invention;

FIG. 4 is a detail view of the filter device shown in FIG. 1 in accordance with yet another embodiment of the present invention;

FIG. 5 is a cross-sectional view of the conductor shown in FIGS. 2-4;

FIG. 6 is an isometric view of the filter device in accordance with the present invention;

FIG. 7 is an isometric view of the filter device in accordance with the present invention;

FIG. 8 is an isometric view of the filter device in accordance with the present invention;

FIG. 9 is a detail schematic view of a tuning arrangement in accordance with another alternate embodiment of the present invention;

FIG. 10 is an isometric view of the filter device connected to a contact arrangement of an implantable medical element;

FIG. 11 is a plot of filter performance showing impedance as a function of frequency;

FIG. 12 is a schematic diagram of the filter device in accordance with yet another embodiment of the present invention;

FIG. 13 is another plot of filter performance showing impedance as a function of frequency;

FIG. 14 is an isometric view of the filter device in accordance with the schematic depicted in FIG. 12;

FIG. 15 is an isometric view of the filter device in accordance with an alternate embodiment of the schematic depicted in FIG. 12;

FIG. 16 is a schematic diagram of the filter device in accordance with yet another embodiment of the present invention;

FIG. 17 is an isometric view of the filter device in accordance with the schematic depicted in FIG. 16; and

FIGS. 18A-18M illustrate a method for fabricating a filter device in accordance with the present invention.

### DETAILED DESCRIPTION

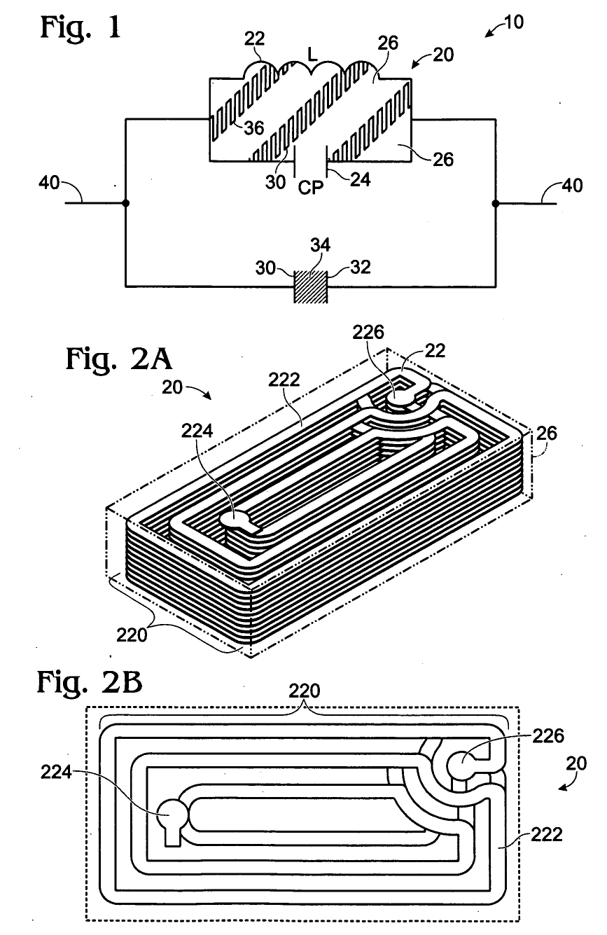

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the filter device of the present invention is shown in FIG. 1, and is designated generally throughout by reference numeral 10.

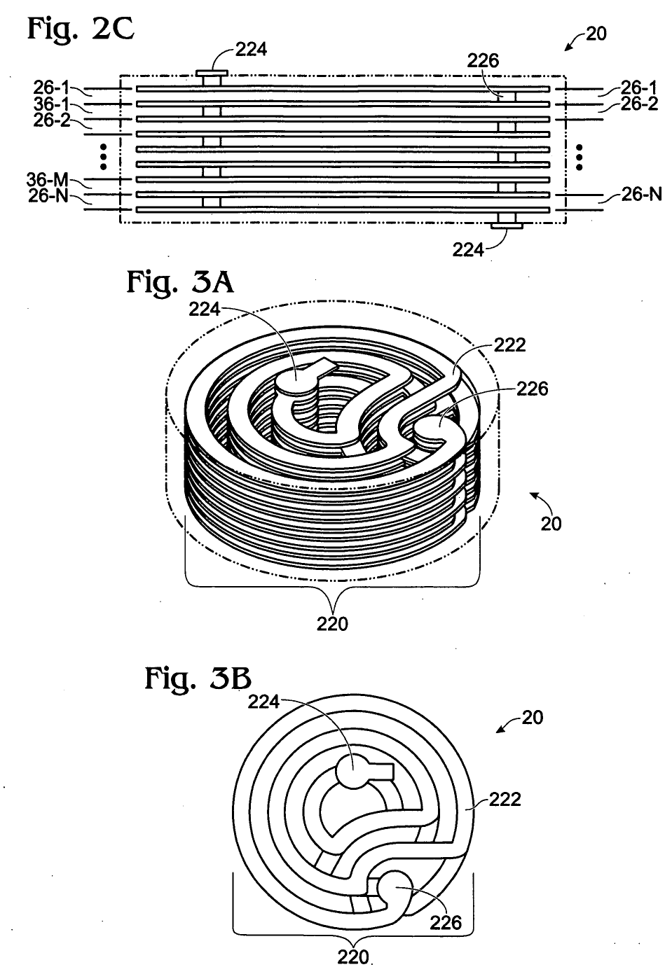

As embodied herein, and depicted in FIG. 1, a schematic diagram of the miniaturized filter device 10 in accordance with one embodiment of the present invention is disclosed. The miniaturized integrated filter device 10 may be employed in any suitable implantable element, such as a lead, a four port lead, or in an implantable medical device itself. The filter device 10 includes a filter component 20 coupled to one or more tuning elements 30. The filter component 20 includes an inductor 22 disposed in parallel with capacitor 24. Capacitor 24 is a parasitic capacitance formed by the inductive structures subsequent described. See, e.g., FIGS. 2-4.

The filter component 20, which will be explained in greater detail below, includes N-circuit layers, where N is an integer greater than or equal to one. Depending on the desired electrical characteristics, such as inductance, capacitance, quality factor, etc., N may be as great as eighty (80) but not limited thereto. Each of the N-circuit layers includes a dielectric material 26 that has conductive material 222 disposed thereon. The dielectric material 26 is characterized by a relatively low dielectric constant. The conductive material 222 is characterized by a relatively high electrical conductivity and arranged in a predetermined pattern on a surface of the dielectric material 26 of each of the N-circuit layers. The conductor 222 on each of the N-circuit layers 26 is coupled to the conductor 222 disposed on an adjacent layer of the N-circuit layers such that the N-circuit layers form an inductor 22 disposed in parallel with parasitic capacitance 24.

The filter component 20 is coupled to one more tuning elements 30. The tuning elements 30 may include an external capacitor 32, high dielectric constant material 36, which is selectively integrated into the inductor 22, and/or other tuning features that are described herein. The tuning elements 30 are selected and configured to cause the LC filter component 20 to resonate at any predetermined frequency. The features of the present invention are configured to optimize the impedance and quality factor (Q) of filter device 10 at the selected resonance frequency.

With respect to tuning elements 30, capacitor 32 may be disposed on an external portion of the filter component 20 in parallel with inductor 22 and capacitance 24. The tuning capacitor 32 includes a dielectric material 34 disposed between the capacitor electrodes. Dielectric material 34 is characterized by a relatively high dielectric constant. The other tuning element 30 is implemented by interleaving layers of dielectric material 36 within layers of the low dielectric constant material 26. Dielectric material 36 is also characterized by a relatively high dielectric constant. The dimensional characteristics of the tuning elements and the predetermined selected resonance frequency are a function of a ratio of the high dielectric constant over the low dielectric constant. The plate area of the external capacitor 32, for example, is inversely proportional to the dielectric constant of the material 34 disposed between the plates for a given capacitance. The capacitance of capacitor 32, of course, determines the resonant frequency, at least in part.

In one realization, filter component 20 includes 18-layers to achieve an inductance of approximately 520 nH. In other embodiments, filter component 20 may be configured to exhibit an inductance within an approximate range between 500-800 nH and a quality factor (Q) greater than 80. The filter device 10 itself is characterized by a quality factor (Q) of approximately 20. The present invention, of course, should not be construed as being limited to the aforementioned embodiments.

Referring to FIGS. 2A-2C, detail views of the filter component 20 depicted in FIG. 1 are shown. FIG. 2A is an isometric view of the filter component 20. As alluded to above, filter component 20 implements an inductor 22 by printing or otherwise forming a conductor 222 arranged in a predetermined pattern 220 on N-layers of relatively low dielectric constant material 26. In this example, the predetermined pattern 220 is a meandered line segment disposed on a substantially rectangular layer of material 26. The conductors 222 on each layer are interconnected by vias 226 to form a three-dimensional inductive coil structure 22 having a parasitic capacitance 24. The conductor 222 is not directly accessible from the exterior of filter component 20 for biocompatibility reasons, but is instead, terminated by transition via 224.

FIG. 2B is a plan view of the filter component 20 depicted in FIG. 2A. FIG. 2B provides a somewhat better view of the meandered pattern 220 disposed on the surface of dielectric 26. Planar conductor patterns 220 are meandered for high density inductance and are chosen for best electrical (D.C. and RF) performance.

FIG. 2C is a cross-sectional view of the filter component 20 depicted in FIG. 2A. The right hand side of the Figure illustrates one embodiment of the invention such that filter component 20 includes N-layers of dielectric material 26, i.e., layers 26-1, 26-2 . . . 26-N. The conductor 222 on each layer 26 is interconnected to the conductor 222 disposed on an adjacent layer 26 by the internal connection provided by vias 226. External access to the conductors 222 are provided at transition vias 224. Inductor 22 may be tuned for optimized filter performance by adding or subtracting inductor turns (layers) either in the design phase or by externally opening/closing the links formed by vias 226. Tuning inductor 22 is one means for accurately centering the filter 10 frequency at the desired resonance frequency.

On the left hand side of the FIG. 2C, an alternate embodiment of the present invention is depicted. In this embodiment, selected layers of low dielectric material 26 are interleaved with an adjacent layer of relatively high dielectric material 36. Thus, from top to bottom, the layers include (in this example) 26-1, 36-1, 26-2 . . . 36-M, 26-N. Interleaving the M-layers of the second dielectric material 36 between the N-layers of the first dielectric material 26 is another method for tuning the filter device 10. The ratio of the relatively high dielectric constant to the relatively low dielectric constant is selected to tune the filter component 20 such that it resonates at an appropriate frequency. This method may also be employed with the external capacitor 32. For example, once the filter component 20 is configured to resonate at a frequency close to the predetermined selected resonance frequency, the external capacitor 32 may be employed to fine tune the filter 10.

As an example, a dielectric material 26, having a dielectric constant of about 7 or 8, may be co-fired with a dielectric material 36, having a dielectric constant of up to 1000. This tuning technique may be employed alone, i.e., it may be used to eliminate the need for an external parallel capacitor 32.

The dialectic materials 26, 36 and the conductive material 222 are selected such that they may be co-fired to produce a multilayered inductor. Multilayer ceramic processes such as LTCC and HTCC may be employed to implement the present invention. Ceramic layer thicknesses may be chosen to optimize density inductance and thermal dissipation for a given filter design. In one embodiment, conductors 222 may be separated by a layer of ceramic material 26 that is in an approximate range of 1.2 mil to 1.7 mil. This arrangement results in the formation of a miniature (110 mils×50 mils×30 mils), high density (approximately 520 nH), high Q (approximately 80) inductor. The proximity of the inductor turns allows for a non linear increase in inductance per turn almost approaching a solenoid effect. This leads to a high Q inductance as the inductance is maximized and the DCR is minimized.

The ceramic materials (26, 36) employed in the present invention are selected to provide relatively advantageous heat dissipation properties. Ceramic materials employed in the present invention may have a thermal conductivity of 3.3 W/m-K. A ceramic layer having a thickness in the range of 1.2 to 1.7 mils will, therefore, substantially prevent overheating of filter component 20 because the dielectric 26 disposed between conductors 222 effectively routes thermal energy away from conductor 222 hot spots. When current flows in conductors 222, heat is generated due to resistive losses in the conductor (I²R losses—electrical energy is converted to heat energy). This heat dissipation feature applies to both direct current flow, pulsed current waveforms and RF currents propagating on the conductor 222. Thus, ceramic layer thicknesses are optimized for both heat dissipation and size (miniaturization). It should also be noted that ceramic material 26 is also biocompatible. Examples of ceramic materials that may be employed in the present invention include, but are not limited to, inert ceramics such as Alumina, Quartz or Polymer. These materials, it should be noted, are also relatively non-magnetic.

With respect to conductors 222, conductor materials are selected based on properties such as conductivity, relatively low DC resistance, as well as RF performance capabilities. Conductors 222 may be selected from a group of materials that includes, but is not limited to: silver (Ag), which has a conductivity σ=6.3×10⁷ S/m; gold (Au) which has a conductivity σ=4.1×10⁷ S/m; copper (Cu), which has a conductivity σ=5.95×10⁷ S/m; tungsten (W); and/or suitably engineered composite materials having the requisite electrical performance characteristics. In fact, any suitable conductive material may be selected based on having the required conductivity characteristics, mechanical properties, DC and RF performance characteristics, non magnetic properties, and its ability to be employed in printing or etching techniques that lend themselves to optimal miniaturization of the component.

With respect to the materials that may be employed in the transition vias 224, an intermediate conductor material may be used to transition between the different internal and external conductor materials employed herein. As noted, conductors 222 may be implemented using silver. Silver is not biocompatible. Ultimately, however, conductors 222 must be coupled to external biocompatible connectors (See, e.g., connector pads 40 in FIG. 6) if the device 10 is to be functional. Accordingly, external conductors 40 may be implemented using materials such as platinum (Pt) or palladium (Pd). Further, the design must ensure that the non-biocompatible conductive materials (e.g., silver) used to implement conductors 222 do not migrate from the interior of the filter component 20 to the exterior thereof. Accordingly, transition vias 224 may be filled with PtAg, PdAg. Other suitable transition materials that function as an interface between the external conductors 40 (Pt or Pd) and the internal conductors 222 (e.g., Ag) may be employed as well. Those skilled in the art will understand that suitable transition materials may be selected based on matching the thermal coefficient of expansions of the external/outer conductors, optimizing process yield and process compatibility, ability to mate to both the internal and external metals (especially under thermally cycled environments). Suitable transition materials must also not separate to form an open circuit.

Referring to FIGS. 3A-3B, detail views of a filter component in accordance with another embodiment of the present invention are shown. In this embodiment, the predetermined pattern or geometry of the filter component is circular in nature. Conductor 222 is connected to vias 224, 226 in a manner that is identical to that described above. In fact, the implementation details described above are fully applicable to this embodiment and are, therefore, omitted from this description for sake of brevity.

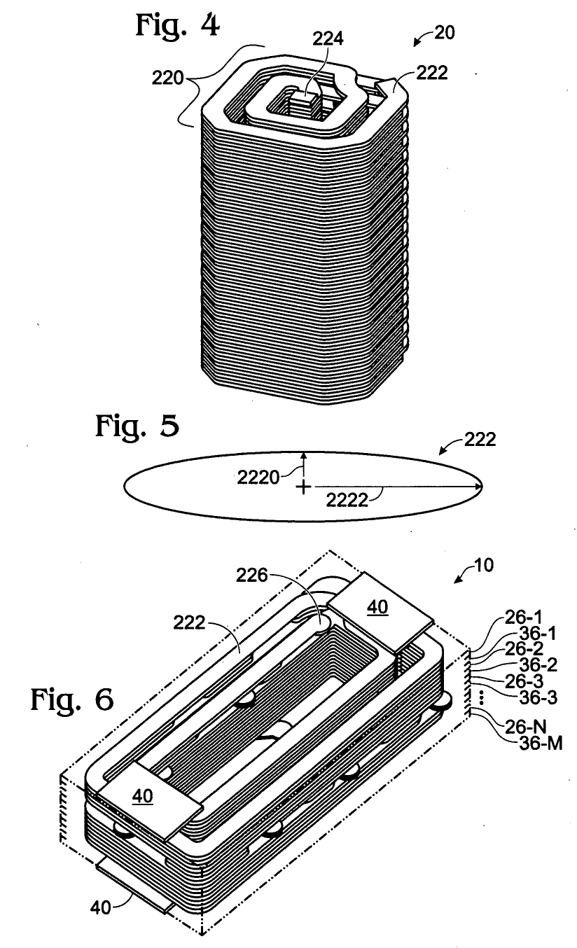

Referring to FIG. 4, a detail view of a filter component in accordance with yet another embodiment of the present invention is shown. In this embodiment, the predetermined pattern or geometry of the filter component is octagonal in nature. Conductor 222 is again connected to vias 224, 226 in a manner that is identical to that described above. The implementation details described above are fully applicable to this embodiment and are, again, omitted from this description for brevity's sake.

Referring to FIG. 5, a cross-sectional view of the conductor 222 is shown. Conductor 222 is characterized by a predetermined cross-sectional shape that is substantially elliptical in nature. The ellipse includes a minor radius 2220 and a major radius 2222. As noted above, the conductor 222 has a D.C. resistance that is less than or equal to 5 Ohms. To achieve a filter Q of approximately 20 or higher, the conductor 222 must have a minimum of 3 skin depths.

Referring to FIG. 6, an isometric view of the filter device 10 in accordance with another alternate embodiment of the present invention is shown. FIG. 6 is an implementation of the device 10 in accordance with the reference elements provided on the left-side of FIG. 2C. In other words, selected layers of low dielectric material 26 are interleaved with an adjacent layer of relatively high dielectric material 36. The layers from top to bottom include layers 26-1, 36-1, 26-2 . . . 36-M, 26-N. As noted above, interleaving the M-layers of the second dielectric material 36 between the N-layers of the first dielectric material 26 is one method for tuning the filter device 10. The ratio of the relatively high dielectric constant to the relatively low dielectric constant is selected to tune the filter component 20 such that it resonates at an appropriate frequency. This embodiment is an example of a filter device 10 that does not need or include a parallel capacitor 32.

After firing, the transition vias 224 (not shown in this view) are connected to their respective I/O conductor pads 40. The external I/O conductors 40, in addition to their connective functions, are configured to seal conductor 222 within the filter component 20 such that the non-biocompatible material comprising conductor 222 is not accessible via the external portion in the manner previously described. Again, I/O connectors 40 are comprised of relatively inert biocompatible materials such as platinum (Pt), Palladium (Pd), etc. Suitable composite materials may also be employed based on their electrical, mechanical, and biocompatibility characteristics.

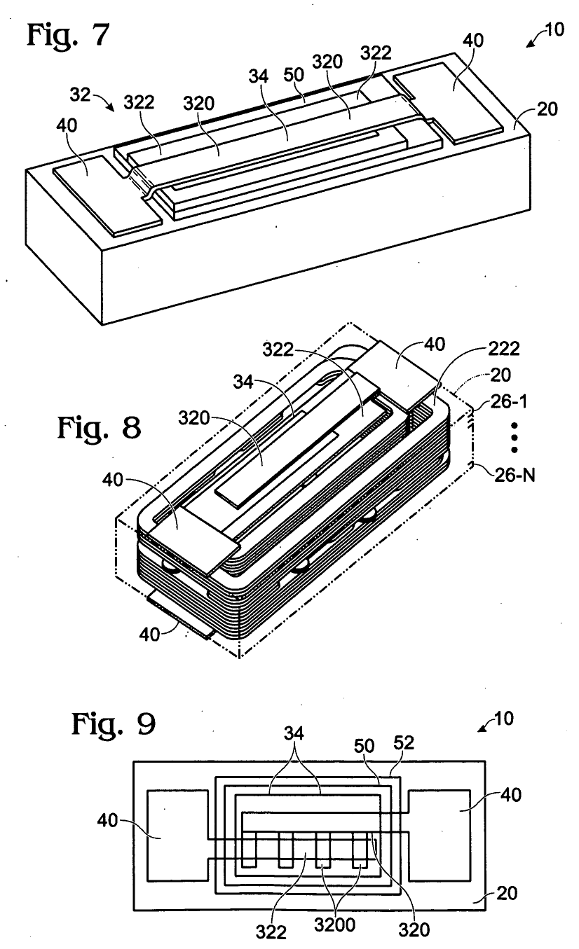

Referring to FIG. 7, an isometric view of the filter device in accordance with yet another alternate embodiment of the present invention is shown. This embodiment is an implementation of the device 10 in accordance with the reference elements provided on the right-side of FIG. 2C. In other words, the filter component 20 includes N-layers of dielectric material 26 ( i.e., layers 26-1, 26-2, . . . 26-N) and an external capacitor 32 is disposed on an exterior portion of the filter component 20 in parallel with the parasitic capacitance 24.

Capacitor 32 includes a bottom conductive plate 322 disposed on the ceramic exterior of component 20, and a top conductive plate 320 having a high dielectric constant material 34 disposed therebetween. Capacitor 32 is connected to the external I/O conductor pads 40. Capacitor 32 is configured to tune the filter component 20 to resonate at the predetermined selected frequency. Capacitor 32 is further encapsulated by a sealant material 50. The sealant material 50 is, of course, biocompatible. However, material 50 is typically a dielectric material that may also be employed to fine tune capacitor 32.

In practice, external conductor patterns may be printed/etched on the exterior surface of component 20 (or a panel when batch processing is performed) to form a parallel plate, edge coupled or some other alternative capacitive structure 32. The external capacitor 32 is, of course, tuned to optimize the performance of the filter device 10 as described previously. The term “optimized” means that filter resonance can be accurately centered by tuning the capacitor 32. The dielectric material 34 may have a very high dielectric constant within a range substantially between 500-1,000. As those skilled in the art will appreciate, a relatively high dielectric constant is suitable for implementing high density capacitors. Those skilled in the art will also appreciate that the dielectric constant range provided above may include a lower bound where the size of the filter component 20 and capacitor 32 permit. It should also be noted that by varying the dielectric constant, capacitance values may be varied widely.

Referring to FIG. 8, an isometric view of the filter device in accordance with yet another alternate embodiment of the present invention is shown. This device is very similar to the embodiment depicted in FIG. 7. The filter component 20 includes N-layers of dielectric material 26 in combination with a parallel plate capacitor 32. However, in this embodiment, capacitor 32 may be tuned by ablation/trimming of the capacitor plates (320, 322). Capacitor 32 may also be tuned by adding additional layers of high dielectric material 34. Multiple passes of the high dielectric material 34 may be deposited using suitable deposition techniques to set the dielectric thickness to a desired level. As an initial point, the capacitor dielectric 34 may be printed at a 0.5 mil thickness to set the capacitance at a lower value. More dielectric material may be deposited or printed on subsequent passes to change/tune the dielectric thickness (and hence, the dielectric value). Of course, the capacitor dielectric thickness is selected to optimize capacitive density, reliability and repeatability. A relatively thick layer of capacitor dielectric, for example, is more reliable. Thinner dielectric layers may result in the presence of pin holes which may result in short circuits. A capacitor 32 having more dielectric layers reduces the likelihood of short circuits and improves yield.

Referring to FIG. 9, a detail schematic view of a tuning element 30 in accordance with yet another alternate embodiment of the present invention is shown. The schematic view is very similar to the capacitor arrangements depicted in FIGS. 7 and 8 with the following exception. The top capacitor plate 320 includes removable fingers 3200. Thus, with FIG. 1 in mind, the tuning element 30 is at least partially implemented by the removable capacitor plate portions 3200. Portions or fingers 3200 are removed as necessary to aid in tuning the filter 10 to resonate at the predetermined selected frequency.

FIG. 9 also shows two dielectric sealants 50 and 52. In this case, the capacitor tuning feature 30 includes the disposition of a third dielectric material 52 over capacitor 32. The dielectric sealants (50, 52) may be printed or etched on the external surface of the component 20, i.e., over both the ceramic and conductor materials. Once applied, the filter device 10 is fired another time. The external sealant materials, of course, are selected to optimize and match the coefficient of thermal expansion of adjacent materials. These materials are also selected for their electrical properties (D.C. and RF), non-magnetic properties, and biocompatibility.

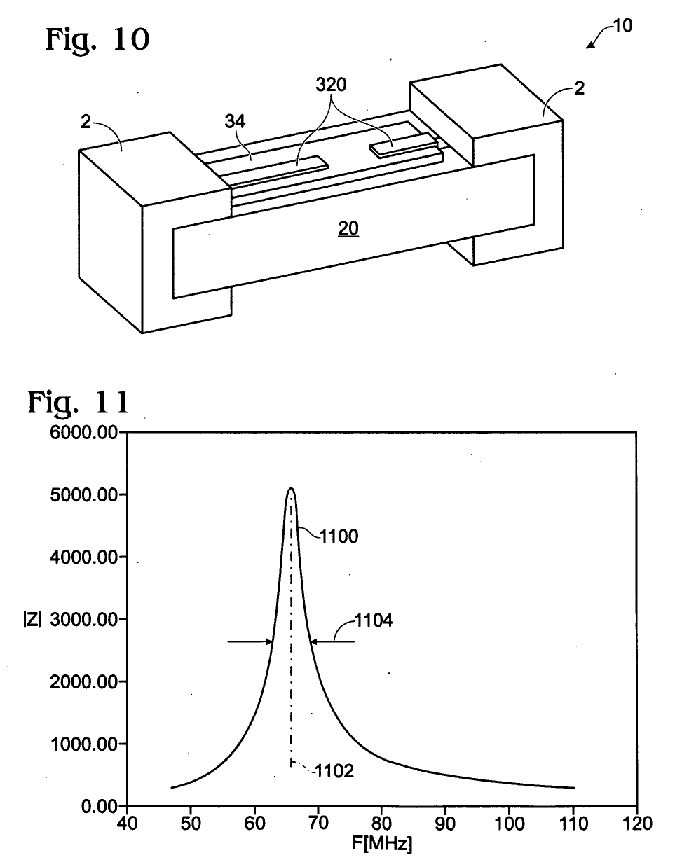

Referring to FIG. 10, an isometric view of the filter device 10 connected to a contact arrangement 2 of an implantable medical element is shown. As noted previously, external conductor patterns 40, 320 are formed on the exterior surface of filter device 10. Input and output pads 40 (not shown in this view) are designed such that they interconnect with the I/O pads 2 of the implantable lead or device. A cross-sectional area of filter device 10 that bisects the major longitudinal axis of device 10 may be on the order of about 1,500 mil². A cross-sectional area of filter device 10 that bisects the major latitudinal axis of device 10 may be on the order of about 5,500 mil². Of course, these dimensions will vary depending on the requirements of the filter 10 design.

FIG. 11 is a plot depicting resonance by showing impedance as a function of frequency. The plot shown is a representative example of the performance of a filter 10 in accordance with the present invention. In this view, peak resonance is achieved at a frequency 1102 that is at approximately 64 MHz, which is a typical MRI frequency. The bandwidth 1104 is suitably wide such that the impedance at resonance 1102 is suitably high.

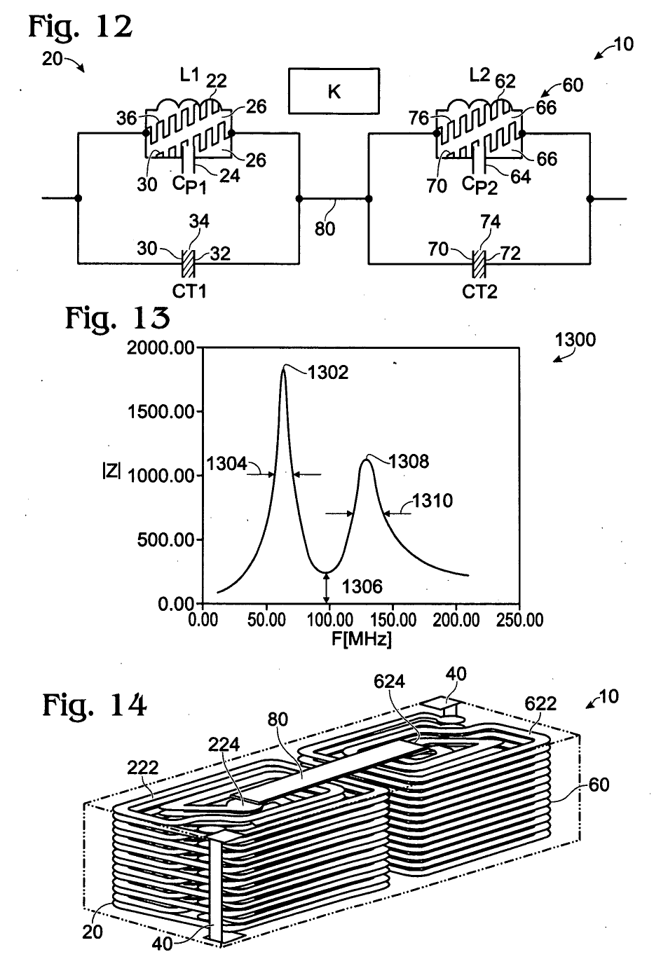

As embodied herein, and depicted in FIG. 12, a schematic diagram of the filter device 10 in accordance with yet another embodiment of the present invention is disclosed. Multiple bandstop filters, resonating at a selection of differing frequencies, may be formed (when connected in series) in a single block. Accordingly, filter device 10 includes multiple filter components (20, 60). Filter component 20 has been described in much detail in the preceding paragraphs. Filter 60 is of the identical or similar design as filter component 20, and therefore, only a brief description is provided. Filter component 60, like filter component 20, includes an inductor 62 disposed in parallel with capacitor 64. The inductor is an N-layered structure formed by laminating and firing N-layers comprising conductors 222 disposed on low dielectric constant material 66. Alternatively, the N-layers may be interleaved with relatively high dielectric layers 76 for tuning purposes in the manner previously described. Capacitor 64 is a parasitic capacitance formed in the manner previously described. Filter component 60 may be disposed in parallel with external capacitor 72. Capacitor 72, of course, includes high dielectric material 74. Again, filter 20 and filter component 60 are realized using the same techniques, and are cascaded to provide multiple resonant frequencies.

FIG. 13 is another plot depicting resonance by showing impedance as a function of frequency. Filter 20 may be configured to resonate at frequency 1302, which is shown herein as substantially equal to 64 MHz. Filter 60, on the other hand, is configured to resonate at frequency 1308, which is substantially equal to about 128 MHz. Both of these frequencies are used in MRI machines. Accordingly, a cascaded device 10 of the type depicted in FIG. 12 is very useful because it may be employed with the MRI machines currently on the market. Note that the filter components (20, 60) may be arranged at a predetermined angular orientation relative to each other to create a predetermined degree of inductive coupling (See, e.g., “K”, FIG. 12) to effect desired bandwidth characteristics (1304, 1306, 1310) as shown in FIG. 13.

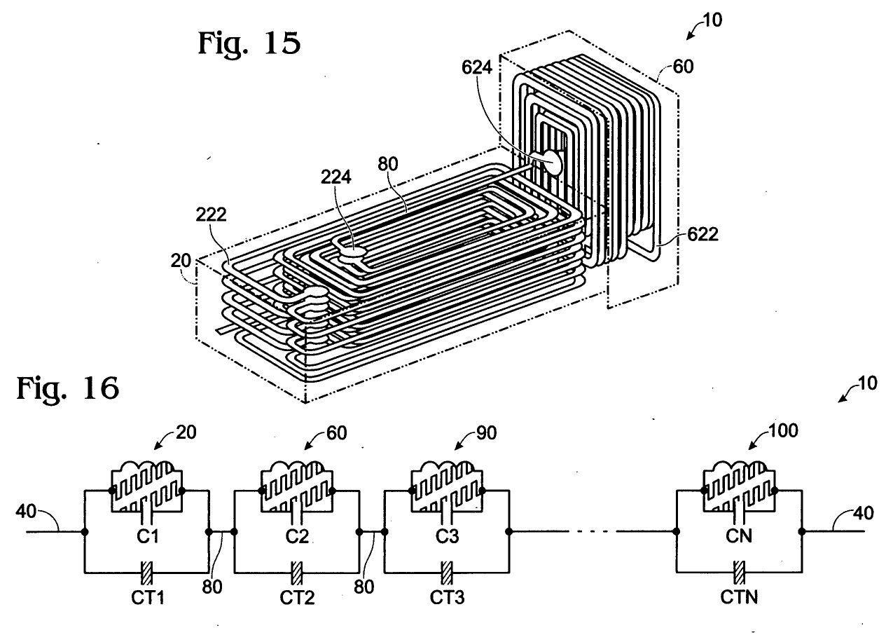

Referring to FIG. 14, an isometric view of the filter device 10 in accordance with an embodiment of the schematic depicted in FIG. 12 is shown. As noted above, each of the plurality of filter components (20, 60, etc.) may be arranged at any predetermined angular orientation relative to its respective adjacent filter component to generate a predetermined degree of inductive coupling. In this view, the conductors 222 of component 20 and conductors 622 of component 60 are disposed in substantially the same plane to maximize the degree of inductive coupling between component 20 and filter component 60. The arrangement depicted in FIG. 15 is at the other extreme. In FIG. 15, filter component 60 is disposed in a substantially orthogonal position relative to adjacent filter component 20 to substantial cancel any inductive coupling between adjacent filter components (20,60). The angular orientation of the filter components (20, 60), therefore, may be arranged at any angle between the two extremes shown in FIG. 14 and FIG. 15 to obtain the desired degree of inductive coupling between adjacent filter components. As noted above, this technique is employed to obtain desired bandwidth characteristics.

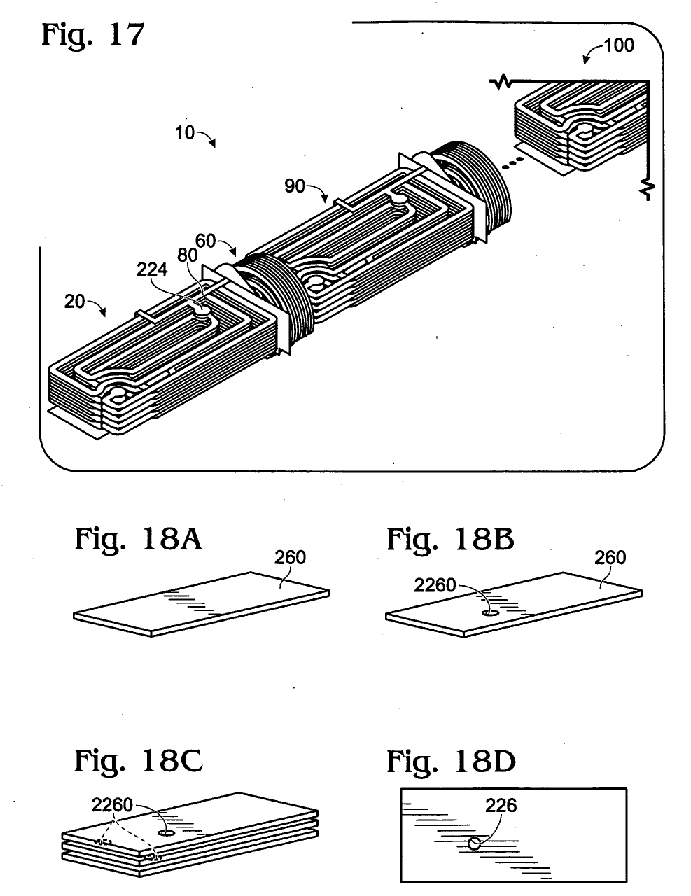

As embodied herein, and depicted in FIG. 16, a schematic diagram of the filter device 10 in accordance with yet another embodiment of the present invention is disclosed. In this embodiment, K-filter components are cascaded together to obtain K-resonant frequencies. K is an integer value greater than one. In the schematic diagram, the filter device 10 includes filter component 20 cascaded with K-1 filter components (60, 90, 100, etc.). The filter components 20, 60, 90, 100, etc. are realized using the same techniques described above in reference to filter component 20. The K-filter components, as noted previously, are cascaded to provide multiple resonant frequencies. FIG. 17 is an isometric view of the filter device 10 in accordance with the schematic diagram shown in FIG. 16 above. This Figure illustrates the interconnection conductor 80 used to interconnect the various filter components (20, 60, 90, 100, etc.). In this embodiment, the filters are shown as being orthogonally disposed relative to their adjacent filter components. Again, the filter components may be disposed at any angular orientation.

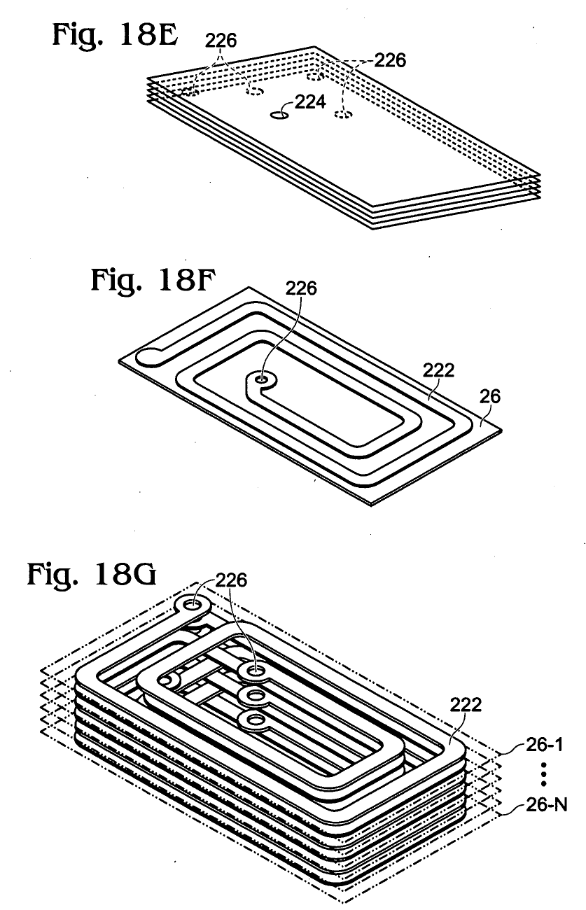

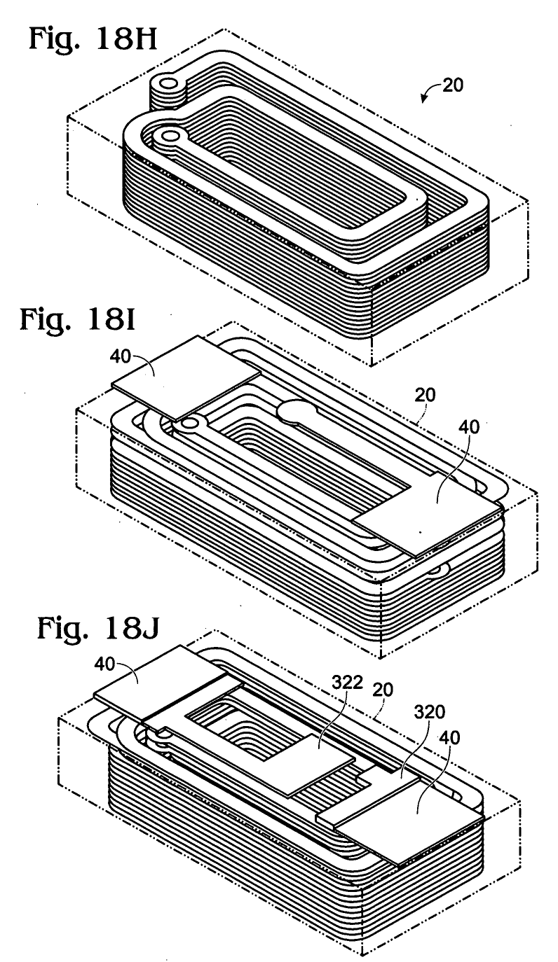

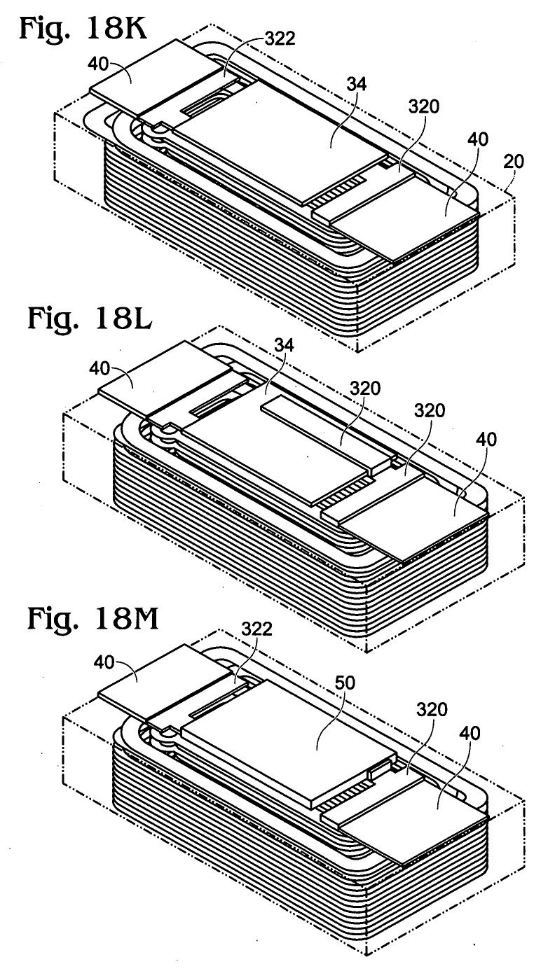

Referring to FIGS. 18A-18M, a method for fabricating a filter device 10 in accordance with one embodiment of the present invention is shown. FIG. 18A shows one layer of green ceramic material. In practice, layer 260 may be arranged in panel form, i.e., it may include many filter components 10. Individual components may be “singulated” from a panel form, post or pre firing. As noted previously, ceramic materials with low dielectric losses are chosen for implementing high Q inductors. In addition to having the characteristics described above, the ceramic material may have a dielectric loss tangent in a range substantially between 0.002 to 0.006. Sheet 260, again as described above, is implemented using a ceramic material that is characterized by high thermal conductivity for optimizing heat dissipation. LTCC materials may be selected that have thermal conductivities in the substantial range between 3.3 to 4.4 W/m-K. HTCC materials may be selected that have thermal conductivities of about 170 W/m-K.

In FIG. 18B, via holes 2260 are punched in the individual ceramic layers 260 to provide routing paths for layer-to-layer interconnections. The via hole 2260 dimensions are selected to optimize the electrical performance (DC, RF) based on the filter 10 performance requirements. Via hole dimensions, for example, in the substantial range between 4 mil to 6 mil may be employed to provide a low DC resistance and good RF transition from layer to layer.

As shown in FIG. 18C, multiple via holes 2260 are typically formed in every layer 260 depending, of course, on the design. Via hole patterns are punched on multiple layers—allowing interconnect routes for a multilayer structure. In FIG. 18D, the via holes 2260 are filled with the conductive material to form the via 226. FIG. 18E illustrates the fact that the via holes 2260 and 2240 must be filled in each of the N-layers 260 to provide layer-to-layer interconnections.

In FIG. 18F, conductor patterns 220 are disposed on each of the N-layers of the dielectric material to form N-circuit layers. This step may be performed by printing the circuit pattern on the surface of the ceramic material. Etching techniques may also be employed to perform this step. This step may be done in conjunction or in parallel with the steps shown in FIGS. 18D-E. Again, conductor 222 thicknesses are chosen for best DC and RF performance. To meet a maximum DCR of 5 Ω, the conductor must have a minimum thickness of approximately 0.7 mil. Conductors 22, as described above, are characterized by a relatively high electrical conductivity. Conductor patterns 200 are formed to optimize the density of the inductors. Conductor patterns may be printed with a minimum width of 5 mils and a minimum height of 0.7 mils. These dimensions do not represent the minimum limits of the printing technology, but they may represent the limits for achieving the aforementioned DCR of 5 Ω. In this embodiment, the conductor spacings are printed at about 3.5 mils. These dimensions provide a dense inductor 22 that meets the DC resistance requirement of about 5Ω. The conductor materials have previously been described.

Once the conductors 222, vias (224, 226) are disposed in the various layers 260, the N-layers 260 are stacked and aligned using suitable registration techniques. In FIG. 18H, the N-circuit layers are integrated to form component 20. The step of integrating the N-circuit layers 260 includes laminating the N-layers of ceramic green-tape material and heating the stacked and aligned N-layers in accordance with a predetermined firing profile. The step of laminating interconnects the N-layers and the interconnecting vias (224, 226). The firing profile refers to the temperature of the oven as a function of time. The temperature is typically cycled from low to high temperature, and back again, to achieve desired electrical and mechanical properties. For example, a component wherein N equals 18 layers, may be employed to achieve an inductance of approximately 550 nH. It should also be noted that the firing profile, which specifies the various temperature levels as a function of time, is a means for tuning filter 10. In other words, selected resonance frequency may be a function of the firing profile. While the illustrations provided herein describe the fabrication of only one component, the filter devices 10 may be processed in bulk such that multiple components are co-fired at one time in panel form. Once fired, the component/panel may be further processed to add additional features to the exterior of the component/panel.

Referring to FIG. 18I, external connections 40 are realized by exposing transition vias 224 (not shown in this Figure) on the surface of the ceramic in the manner previously described. The I/O pads 40 are coupled to transition vias 224 and are added in a post firing printing/etching process. However, I/O pads 40 may also be added by way of a pre-firing printing/etching process. Again, as previously described, the I/O pads 40 are designed such that they block/seal/prevent internal conductor material 222 from leaching into the ambient environment. Unless prevented from doing so, internal silver (Ag) can migrate under certain ambient conditions, e.g., humidity, bias, etc. The transition metals and the I/O pad metals are selected to prevent this from occurring. I/O pads 40 are further designed such that they can be connected to external connectors on the implantable element by a welding or soldering process. I/O pads 40 may also be formed in multiple print passes or plated to achieve a reliable metallization thickness at the pad location. Finally, the terminal pads 40 and the capacitor structure 20 are interconnected in parallel to form an integrated filter device 10 (See, e.g., schematic diagram of FIG. 1). Once the terminal pads 40 are disposed on the component 20, the laminated component is fired at a temperature profile chosen such that the materials bond together forming a rigid single component.

In similar fashion, FIGS. 18J-18L show one method for realizing external capacitor 32. The printing and/or etching steps have been previously described and are not repeated for brevity's sake. Nonetheless, FIG. 18J shows the bottom capacitor plate 322 being disposed on the exterior of component 20. In FIG. 18K, the dielectric material 34 is disposed overtop capacitor plate 322. In FIG. 18L, the top capacitor plate is formed over dielectric 34. In FIG. 18M, the filter component 20 may be at least partially encapsulated in a biocompatible sealant materials 50, 52. The purpose and function of the sealants has been previously described.

Accordingly, whether the external capacitor 32, the M-interleaved layers of dielectric 36, and/or the sealants (50, 52) are employed, the present invention provides various tuning elements 30 that may be implemented either before the step of integrating or after the step of integrating, to form a filter component having the requisite characteristics.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. An integrated filter device for an implantable element, the device comprising:
at least one filter component including N-circuit layers, N being an integer greater than or equal to one, each of the N-circuit layers including a first dielectric material having a first conductive material disposed thereon, the first dielectric material being characterized by a relatively low dielectric constant, the first conductive material being characterized by a relatively high electrical conductivity and arranged in a predetermined pattern on a surface of the first dielectric material of each of the N-circuit layers, the first conductive material on each of the N-circuit layers being coupled to the first conductive material disposed on an adjacent layer of the N-circuit layers such that the N-circuit layers form an inductor disposed in parallel with a first capacitance; and
at least one tuning element coupled to the at least one filter component and configured to tune the at least one filter component to resonate at a predetermined selected resonance frequency, the at least one tuning element including a second dielectric material characterized by a relatively high dielectric constant, a dimension of the at least one tuning element and the predetermined selected resonance frequency being a function of a ratio of the high dielectric constant over the low dielectric constant.

2. The device of claim 1, wherein the at least one filter component includes a plurality of filter components such that the filter device is configured to resonate at a plurality of predetermined selected resonance frequencies.

3. The device of claim 2, wherein each of the plurality of filter components are arranged at a predetermined angular orientation relative to an adjacent filter component to generate a predetermined degree of inductive coupling between adjacent filter components to effect predetermined bandwidth characteristics of the plurality of predetermined selected resonance frequencies.

4. The device of claim 2, wherein each of the plurality of filter components are arranged in a substantially orthogonal position relative to an adjacent filter component to substantial cancel inductive coupling between adjacent filter components.

5. The device of claim 1, wherein the first dielectric material of the N-circuit layers includes a ceramic material.

6. The device of claim 5, wherein the ceramic material is selected from a group of ceramic materials that include alumina, quartz or polymer materials.

7. The device of claim 1, wherein the relatively low dielectric constant of the first dielectric material is greater than one (1).

8. The device of claim 7, wherein the relatively low dielectric constant of the first dielectric material is within a range substantially between two and ten.

9. The device of claim 1, wherein each of the N-circuit layers including the first dielectric material is characterized by a thickness in a range between one (1.0) and two (2.0) mils.

10. The device of claim 1, wherein each layer of the N-circuit layers is characterized by a thermal conductivity in a range between 3.0 W/m-K and 200 W/m-K.

11. The device of claim 1, wherein the first conductive material is selected from a group of materials that includes silver (Ag), gold (Au), tungsten (W), a composite material or copper (Cu).

12. The device of claim 11, wherein the relatively high electrical conductivity of the first conductive material is a conductivity within a range including 4.0×10⁷ S/M through 7.0×10⁷ S/M.

13. The device of claim 1, wherein the predetermined pattern of the first conductive material is characterized by a meandered line segment.

14. The device of claim 1, wherein the first conductive material is characterized by a predetermined cross-sectional shape and predetermined cross-sectional area.

15. The device of claim 14, wherein the first conductive material is characterized by a D.C. resistance is less than or equal to 5 Ohms.

16. The device of claim 14, wherein the first conductive material is characterized by a minimum of substantially three (3) skin depths.

17. The device of claim 14, wherein the predetermined cross-sectional shape is substantially elliptical.

18. The device of claim 1, wherein an inductance of the inductor is within an approximate range between 500-800 nH and the at least one filter component is characterized by a quality factor (Q) greater than 20.

19. The device of claim 1, wherein a cross-sectional area of the at least one filter component is less than 2,000 mil².

20. The device of claim 1, wherein a cross-sectional area of the at least one filter component is less than 7,000 mil².

21. The device of claim 1, wherein N is within a range between 1 and 80.

22. The device of claim 1, wherein the relatively high dielectric constant of the second dielectric material is characterized by a dielectric constant within a range between 100 and 1,000 based on the predetermined selected resonance frequency.

23. The device of claim 1, wherein the at least one tuning element includes at least one second capacitor disposed in parallel with the first capacitance.

24. The device of claim 23, wherein the at least one second capacitance is configured as a parallel plate capacitor disposed on an exterior portion of the at least one filter component, the at least one second capacitor having a first conductive plate and a second conductive plate with the second dielectric material disposed therebetween.

25. The device of claim 23, wherein the at least one second capacitor includes at least one capacitor tuning feature configured to tune the at least one filter component to resonate at the predetermined selected resonance frequency.

26. The device of claim 25, wherein the at least one capacitor tuning feature includes one or more removable capacitor portions.

27. The device of claim 26, wherein the at least one capacitor tuning feature includes the disposition of a third dielectric material over the at least one second capacitor.

28. The device of claim 25, further comprising at least one connective conductor configured to couple the at least one second capacitor and the first conductive material such that the first conductive material is not accessible via the external portion, the at least one connective conductor being comprised of a relatively inert biocompatible material.

29. The device of claim 28, wherein the at least one connective conductor is selected from a group of substantially inert conductors including at least platinum (Pt), a composite material or palladium (Pd).

30. The device of claim 25, wherein the at least one connective conductor is connected to the first conductive material at a transition point.

31. The device of claim 30, wherein the transition point is disposed in a via filled with a material selected from a group of materials including PtAg, a composite material or PdAg.

32. The device of claim 1, wherein the relatively high dielectric constant of the second dielectric material is in a range substantially between 500-1,000.

33. The device of claim 1, wherein the ratio of the high dielectric constant over the low dielectric constant is in a range substantially between 250 and 500.

34. The device of claim 1, wherein the at least one tuning element is formed by interleaving M-layers of the second dielectric material between the N-layers of the first dielectric material, the ratio of the relatively high dielectric constant to the relatively low dielectric constant being selected to tune the at least one filter component to resonate at substantially the predetermined selected resonance frequency.

35. The device of claim 1, wherein the at least one tuning element comprises:
M-layers of the second dielectric material interleaved between the N-layers of the first dielectric material, the ratio of the relatively high dielectric constant to the relatively low dielectric constant being selected to tune the at least one filter component to resonate at a frequency that is within a range of frequencies that includes the predetermined selected resonance frequency;
at least one second capacitance disposed in parallel with the first capacitance and configured as a parallel plate capacitor disposed on an exterior portion of the at least one filter component, the at least one second capacitor having a first conductive plate and a second conductive plate with the second dielectric material or a third dielectric material disposed therebetween, the third dielectric material being characterized by a relatively high dielectric constant, the at least one second capacitance being configured to tune the at least one filter component to resonate at the predetermined selected resonance frequency.

36. A method for making a miniaturized integrated filter device for an implantable element, the method comprising:
a) providing N-layers of dielectric material, the dielectric material being characterized by a relatively low dielectric constant, N being an integer value greater than or equal to one;
b) disposing a first conductive material on each of the N-layers of dielectric material to form N-circuit layers, the first conductive material being characterized by a relatively high electrical conductivity and arranged in a predetermined pattern on a surface of the first dielectric material;
c) integrating the N-circuit layers to form an inductor disposed in parallel with a first capacitance; and
d) providing at least one tuning element either before the step of integrating or after the step of integrating to form a filter component, the at least one at least one tuning element including a second dielectric material characterized by a relatively high dielectric constant and configured to tune the filter component to resonate at a predetermined selected resonance frequency, a dimension of the at least one tuning element and the predetermined selected resonance frequency being a function of a ratio of the high dielectric constant over the low dielectric constant.

37. The method of claim 36, further comprising:
repeating steps a) through d) to form at least one second filter component characterized by at least one second predetermined resonance frequency; and
coupling the filter component to the at least one second filter component, the at least one second filter component being disposed in a substantially orthogonal arrangement to substantially minimize inductive coupling between the filter component and the at least one second filter component.

38. The method of claim 36, further comprising:
repeating steps a) through d) to form at least one second filter component characterized by at least one second predetermined resonance frequency to form a plurality of adjacent filter components; and
coupling at least one of the filter component and the least one second filter component to an adjacent filter component at a predetermined angular orientation to select a predetermined degree of coupling between the adjacent filter components to selectively control bandwidth characteristics within a frequency band including the plurality of predetermined selected resonance frequencies.

39. The method of claim 36, wherein the step of providing N-layers of dielectric material includes providing N-layers of ceramic green-tape material selected from a group of materials including alumina, quartz or polymer materials.

40. The method of claim 39, wherein the step of integrating the N-circuit layers further comprises:
laminating the N-layers of ceramic green-tape material; and
heating the N-layers of ceramic green-tape material in accordance with a predetermined firing profile, the predetermined firing profile specifying various temperature levels as a function of time.

41. The method of claim 40, wherein the predetermined selected resonance frequency is a function of the firing profile.

42. The method of claim 40, wherein each of the N-circuit layers is characterized by a thickness in a range between one (1.0) and two (2.0) mils.

43. The method of claim 40, wherein each layer of the N-circuit layers is characterized by a thermal conductivity in a range between 3.0 W/m-K and 200 W/m-K.

44. The method of claim 36, wherein the step of providing at least one tuning element further comprises interleaving M-layers of the second dielectric material between the N-layers of the first dielectric material, the ratio of the relatively high dielectric constant to the relatively low dielectric constant being selected to tune the at least one filter component to resonate at substantially the predetermined selected resonance frequency.

45. The method of claim 36, wherein the step of providing at least one tuning element further comprises:
disposing at least one second capacitance in parallel with the first capacitance;
coupling the at least one second capacitor to the first conductive material via a connective conductor such that the at least one second capacitor is disposed in parallel with the first capacitance, the at least one connective conductor being comprised of a relatively inert biocompatible conductive material such that the first conductive material is substantially inaccessible via the external portion.

46. The method of claim 45, further comprising the step of tuning the at least one second capacitor such that the band stop filter is characterized by the predetermined resonance frequency.

47. The method of claim 36, wherein the first conductive material is selected from a group of materials that includes silver (Ag), gold (Au), a composite material, copper (Cu), or a material having a conductivity within a range including 4.0×10⁷ S/M through 7.0×10⁷ S/M.

48. The method of claim 36, wherein the first conductive material is characterized by a D.C. resistance is less than or equal to 5 Ohms and is characterized by a minimum of three (3) skin depths.
